(19) United States
(12) Patent Application Publication
(10) Pub. No.: US 2003/0030016 A1
(43) Pub. Date: Feb. 13, 2003

(54) Reticles and rapid reticle-evaluation methods for use in charged-particle-beam microlithography

(75) Inventor: Tomoharu Fujiwara, Ageo-shi (JP)

Correspondence Address: KLARQUIST SPARKMAN, LLP, One World Trade Center, Suite 1600, 121 S.W. Salmon Street, Portland, OR, 97204, US

(73) Assignee: Nikon Corporation

(21) Appl. No.: 10/196,537

(22) Filed: Jul. 15, 2002

(30) Foreign Application Priority Data
Aug. 7, 2001 (JP) 2001-239021

(51) Int. Cl. G01V 8/00; G01N 21/86

(52) U.S. Cl. 250/559.3

(57) ABSTRACT

Reticles and reticle-evaluation methods are provided that allow charged-particle-beam (CPB) reticles to be evaluated quickly and accurately. The reticles include one or more device-pattern regions. Alignment-pattern regions are arranged in respective rows along the “upper” and “lower” edges of the device-pattern region(s). Each device-pattern region includes multiple subfields into which a device pattern is divided and defined. Also flanking each device-pattern region are respective evaluation-pattern regions situated along the “left” and “right” edges of the device-pattern region(s). Each evaluation-pattern region includes multiple small membrane regions each having a respective subfield that defines a respective evaluation pattern. The evaluation pattern includes various lines having respective widths, positions, and shapes that are measured and evaluated. If the measurement data agree with prescribed data, then the reticle is accepted for use in performing CPB microlithography. Otherwise, the reticle is regarded as having failed the evaluation.

### FIELD

This disclosure pertains to microlithography (transfer of a pattern from a reticle or mask to a substrate), which is a key technology used in the fabrication of microelectronic devices such as integrated circuits, displays, magnetic heads, and micromachines. More specifically, the disclosure pertains to microlithography performed using a charged particle beam, such as an electron beam. Even more specifically, the disclosure pertains to reticles as used in charged-particle-beam (CPB) microlithography and to methods for evaluating such reticles.

### BACKGROUND

The currently most promising approach to charged-particle-beam (CPB) microlithography is the so-called “divided-reticle” approach, in which the pattern is defined on a “segmented” reticle divided into a large number of individual exposure units (usually termed “subfields”) each defining a respective portion of the overall pattern defined on the reticle. A charged-particle illumination beam is directed at the subfields in a sequential manner, and respective images of the subfields are transferred by a patterned beam to the surface of a “sensitive” substrate on which the images are formed in a contiguous manner. I.e., the respective images are formed at respective locations on the substrate in a manner serving to “stitch” the images together and form the entire pattern on the substrate. By “sensitive” is meant that the upstream-facing surface of the substrate is coated with a substance (termed a “resist”) that is imprintable with the images.

One type of reticle commonly used with divided-reticle CPB microlithography is a “stencil” reticle in which pattern elements are defined as respective voids in a membrane of the reticle. The voids, having respective shapes corresponding to the shapes of the respective pattern elements defined by the voids, transmit the beam with substantially no scattering of charged particles of the beam. The reticle membrane, in contrast, transmits the beam with significant forward scattering of charged particles.

For exposure, the stencil reticle is positioned within the CPB optical system of the microlithography tool. The CPB optical system includes an illumination-optical system that directs an “illumination beam” to the desired location on the reticle. The beam passing through the reticle (this beam is now termed the “patterned beam” because it carries an aerial image of the pattern portion defined by the illuminated portion of the reticle) is projected by a “projection-optical system” onto a respective selected location on the substrate.

As noted above, the subfields on the reticle are exposed in a sequential manner. This exposure requires lateral deflections of the illumination beam and patterned beam, coordinated with motions of the reticle and substrate. For achieving these respective movements of the reticle and substrate, the reticle and substrate are mounted on respective “stages.”

In this divided-reticle approach to CPB microlithography, the respective images of the subfields must be stitched together with extremely high accuracy on the substrate. For this reason, whenever the reticle stage and the substrate stage are moved during exposure, it is necessary to position both stages with extremely high accuracy relative to the projection-optical system. Extremely high accuracy in stage positioning also is required for achieving accurate superpositioning of subsequent chip layers on previously formed layers on the substrate (this is termed “overlay accuracy”).

Reticles (also termed “masks” in the art) generally are manufactured by fabrication processes involving etching and oxidation steps, and in which the pattern is “written” on a reticle substrate using a “mask-writing” apparatus. In recent years, as active-circuit elements in microelectronic devices have become increasingly smaller and more densely integrated, the accuracy requirements with respect to the positions and shapes of pattern elements formed on the reticle have become increasingly exacting.

To achieve position and shape accuracy of pattern elements defined on the reticle, not only must high position and shape accuracy be achieved during reticle manufacture, but also deformations of the reticle must be taken into account. Reticle deformations can occur from any of various causes, such as gravitational sagging of the reticle membrane and stresses imparted to the reticle as the reticle is mounted to the reticle stage. For example, in a stencil reticle, the pattern-element-defining voids are defined in a silicon membrane having a thickness of approximately 2 μm. With such a membrane, deformation is especially prone to occur at locations in which voids having various shapes have been defined.

Position and shape accuracy of pattern elements defined in a fabricated reticle require that reticle inspections be performed before exposures are performed using the reticle. However, it is unrealistic to inspect each and every pattern element on a reticle because an enormous amount of time would be required to complete the inspection.

### SUMMARY

In view of the shortcomings of conventional reticles as summarized above, the present invention provides, inter alia, reticles and reticle-evaluation methods that achieve evaluations of reticle-pattern accuracy in a short amount of time compared to conventional practice.

According to a first aspect of the invention, divided reticles are provided for use in charged-particle-beam (CPB) microlithography. The reticle defines features of a pattern to be transferred to a substrate, wherein the features of the pattern have differences in at least one transmission characteristic with respect to a reticle membrane. Hence, the reticle can be a stencil reticle or a continuous membrane reticle, for example. An embodiment of such a reticle comprises at least one device-pattern region comprising multiple small membrane regions each including a respective subfield defining a respective portion of the pattern to be transferred to the substrate. The small membrane regions are arranged as an array in the device-pattern region. The reticle also includes at least one evaluation-pattern region, situated outside the device-pattern region on the reticle, including at least one small membrane region defining a respective reticle-evaluation pattern. The evaluation-pattern region desirably flanks an edge of the device-pattern region. Desirably, the reticle comprises multiple evaluation-pattern regions flanking respective edges of the device-pattern region. The reticle can further comprise at least one alignment-pattern region, situated outside the device-pattern region on the reticle, including at least one small membrane region defining a respective alignment pattern. Each evaluation-pattern region desirably comprises multiple small membrane regions, each defining a respective reticle-evaluation pattern, arranged along an edge of the device-pattern region.

The reticle can comprise multiple device-pattern regions each including at least one respective evaluation-pattern region, in which instance the reticle desirably includes at least one respective evaluation-pattern region situated outside and associated with each device-pattern region on the reticle.

Each reticle-evaluation pattern desirably comprises an array of multiple mark groups. In such an instance each mark group desirably comprises features such as isolated lines, diagonal lines, line groups including lines of gradated length, and line patterns for evaluating fine end-pattern processing. The line pattern for evaluating fine end-pattern processing desirably comprises a first line having a step-wise concave terminus and a second line having a step-wise convex terminus.

According to another aspect of the invention, methods are provided for evaluating a divided reticle for use in performing CPB microlithography. In an embodiment of such a method the reticle is configured so as to at least one device-pattern region comprising multiple small membrane regions each including a respective subfield defining a respective portion of the pattern to be transferred to the substrate. The small membrane regions are arranged as an array in the device-pattern region. The reticle also includes at least one evaluation-pattern region, situated outside the device-pattern region on the reticle, including at least one small membrane region defining a respective reticle-evaluation pattern. An image of the reticle-evaluation pattern is projected onto a substrate. The projected image is evaluated by determining one or more of positions, line widths, and shapes of features of the reticle-evaluation pattern as projected onto the substrate, so as to obtain reticle-evaluation data. These determinations can be performed using a scanning electron microscope or optical microscope, for example. The reticle-evaluation data are compared with corresponding prescribed data for the reticle. The method can further comprise the step of using the reticle for performing CPB microlithography based on results obtained in the comparing step. Desirably, reticle evaluation is performed before using the reticle for performing CPB microlithography.

After determining one or more of positions, line widths, and shapes of features of the reticle-evaluation pattern as projected onto the substrate, if the respective measured data on these parameters satisfy the prescribed data, then the reticle is regarded as having “passed” the evaluation protocol. If the reticle does not satisfy the prescribed data, then the reticle is regarded as having failed the evaluation protocol. Desirably, the reticle-evaluation pattern is sufficient for evaluating errors in placement of pattern elements accompanying changes in reticle stress, and for evaluating changes in pattern-element line width resulting from proximity effects arising during reticle writing.

There are no particular limitations on the type of reticle to which the present invention applies. I.e., applicable types of reticles include the so-called “stencil” reticles (in which pattern elements are defined by respective voids in a reticle membrane) and “continuous membrane” reticles (in which units of a high-scattering substance are patterned on a continuous low-scattering membrane).

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic plan view of a device-pattern region of a segmented reticle according to a representative embodiment, showing evaluation-pattern regions flanking the device-pattern region.

FIG. 2 is a plan view of a representative embodiment of an evaluation pattern, including an enlargement of a portion of the pattern.

FIG. 3 is a schematic elevational diagram of a representative embodiment of a divided-reticle CPB microlithography system.

FIG. 4(A) is a schematic plan view of a representative embodiment of a reticle for use in CPB microlithography, including a partial enlargement showing two small membrane regions including respective skirts and subfields.

FIG. 4(B) is a schematic oblique view of a portion of the reticle shown in FIG. 4(A), showing especially the structure of support struts and small membrane regions.

FIG. 5 schematically depicts the manner in which subfield images are stitched together on the substrate to form a single contiguous transferred pattern on the substrate.

### DETAILED DESCRIPTION

The invention is described below in the context of representative embodiments that are not intended to be limiting in any way. The embodiments are described in the context of an electron-beam microlithography system as a representative charged-particle-beam (CPB) microlithography system. It will be understood that the principles described below are applicable with equal facility to microlithography systems utilizing an alternative type of charged particle beam, such as an ion beam. It also will be understood that the principles described herein are applicable to various types of reticles usable for CPB microlithography, including so-called “stencil” reticles and “continuous membrane” reticles. Features can be defined on such reticles based on patterned differences in transmission characteristics such as absorption, scattering angle, or other characteristics. Microlithography systems based on optical radiation such as visible, ultraviolet, or X-ray radiation or radiation at other wavelengths can be similarly configured.

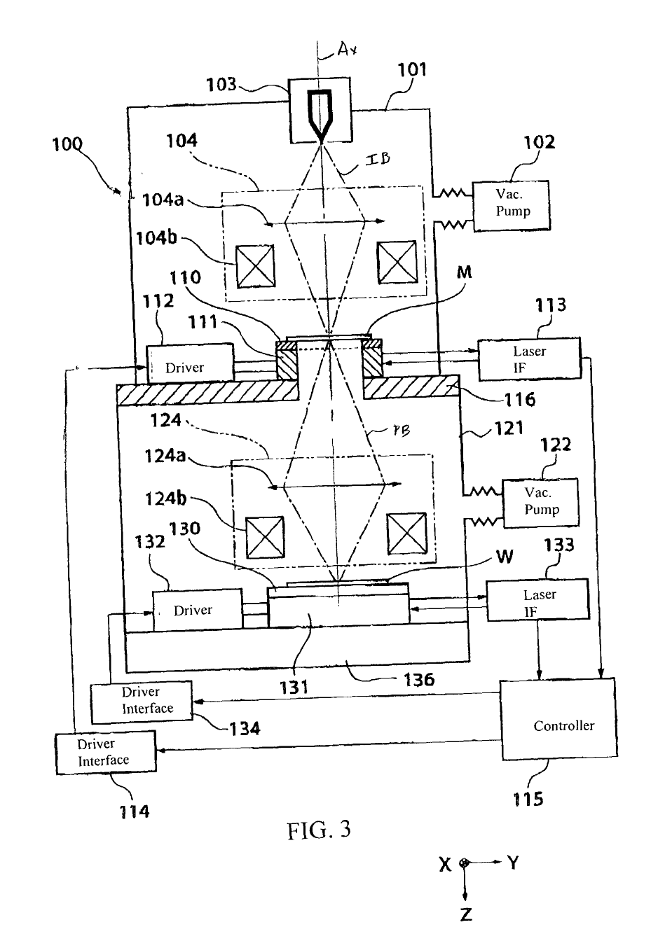

Turning first to FIG. 3, a representative embodiment of an electron-beam microlithography system 100 is shown schematically. The system 100 comprises a first (“upper”) optical column 101 configured as a vacuum chamber in this embodiment. The atmosphere inside the upper optical column 101 is evacuated to a suitable vacuum level using a vacuum pump 102 connected to the upper optical column 101.

An electron gun 103 is situated at the extreme upstream (topmost in the figure) portion of the upper optical column 101, and emits an electron beam (“illumination beam” IB) in a downstream direction (downward in the figure) along an optical axis Ax. Downstream of the electron gun 103 are an illumination-optical system 104 and a reticle M. The illumination-optical system 104 comprises a condenser lens 104a, a deflector 104b, and other components as required to cause the illumination beam IB to irradiate a desired region on the reticle M.

The illumination beam IB emitted from the electron gun 103 is condensed by the condenser lens 104a for illuminating the reticle M. The deflector 104b deflects the illumination beam IB in one or more lateral directions (e.g., Y-direction in the figure) on the reticle M within the optical field of the illumination-optical system 104. For example, a reticle M as used for CPB microlithography typically is divided into multiple exposure units (usually configured as “subfields”) that are illuminated by the illumination beam IB in a sequential manner. The exposure units are arrayed in rectilinear columns and rows on the reticle, wherein each row typically has a length (e.g., in the Y-direction in the figure) substantially equal to the width of the optical field of the illumination-optical system 104. In FIG. 3, the illumination-optical system 104 is depicted as having only a single optical unit (i.e., the condenser lens 104a). An actual illumination-optical system typically has multiple units of lenses, beam-shaping apertures, and the like.

The reticle M is secured by electrostatic attraction, vacuum suction, or other suitable means to a reticle chuck 110 mounted on an upstream-facing surface of a reticle stage 111. The reticle stage 111, in turn, is mounted on and is movable relative to a base 116.

The reticle stage 111 is actuated for movement in at least the X- and Y-directions by a reticle-stage driver 112 operably connected to the reticle stage 111. Although the reticle-stage driver 112 is depicted in the figure to the left of the reticle stage 111, the driver 112 typically is incorporated into the actual mechanism of the reticle stage 111. The reticle-stage driver 112 is connected to a controller 115 via a drive interface 114. In addition, a laser interferometer (IF) 113 is situated relative to the reticle stage 111 (on the right side of the reticle stage 111 in the figure). Actually, the laser interferometer 113 comprises at least two laser interferometers, one for detecting reticle-stage position in the X-direction and another for detecting reticle-stage position in the Y-direction in the figure. For use with these laser interferometers, respective moving mirrors (not shown) are mounted along respective edges of the reticle stage 111. The outwardly facing side surfaces of the moving mirrors are polished to high precision and used as the reflecting surfaces for the respective laser interferometers.

The laser interferometer 113 is connected to the controller 115 and serves to obtain accurate data concerning the position of the reticle stage 111 in the X-direction and Y-direction. The positional data obtained by the laser interferometer 113 is routed to the controller 115. To position the reticle stage 111 at a target position, a respective command is transmitted from the controller 115 to the drive interface 114. The drive interface 114, in response to the command, appropriately energizes the driver 112 to move the stage 111 to the corresponding position. The components 111-115 functioning in this manner achieve accurate, real-time, feedback control of the position of the reticle stage 111.

A second (“lower”) optical column 121 is situated downstream of the base 116. The lower optical column 121 is configured as a vacuum chamber in this embodiment and also serves as a “wafer chamber.” The atmosphere inside the lower optical column 121 is evacuated to a suitable vacuum level using a vacuum pump 122 connected to the lower optical column 121. Situated inside the lower optical column are a wafer W and a “projection-optical system” 124 including a projection lens 124a and a deflector 124b.

The electron beam passing through the reticle M is termed the “patterned beam” PB. The patterned beam PB is condensed by the condenser lens 124a and deflected as required by the deflector 124b to form a focused image at a prescribed location on the wafer W of the illuminated region on the reticle M. Although, in the figure, the projection-optical system 124 is depicted as having only one optical unit (i.e., the projection lens 124a), the projection-optical system 124 actually includes multiple (at least two) optical units. The optical units can comprise respective lenses only or respective lenses and deflector coils as required for proper image formation and for aberration correction. The combination of the illumination-optical system 104 and projection-optical system 124 is the “CPB-optical system” or “exposure-optical system.”

The wafer W is held by electrostatic attraction, vacuum suction, or other suitable means to a wafer chuck 130 mounted on an upstream-facing surface of a wafer stage 131. The wafer stage 131, in turn, is mounted on and movable relative to a base 136.

The wafer stage 131 is actuated for movement in at least the X-direction and Y-direction by a wafer-stage driver 132 operably connected to the wafer stage 131. Although the wafer-stage driver 132 is depicted to the left of the wafer stage 131, the driver 132 typically is incorporated into the actual mechanism of the wafer stage 131 in a manner similar to that of the reticle stage 111. The wafer-stage driver 132 is connected to the controller 115 via a drive interface 134. In addition, a laser interferometer (IF) 133 is situated relative to the wafer stage 131 (on the right side of the wafer stage 131 in the figure). Actually, the laser interferometer 133 comprises at least two laser interferometers, one for detecting wafer-stage position in the X-direction and another for detecting wafer-stage position in the Y-direction in the figure. For use with these laser interferometers, respective moving mirrors (not shown) are mounted along respective edges of the wafer stage 131. The side surfaces of the outside of the moving mirrors are polished to high precision and used as the reflecting surfaces for the respective laser interferometers. The laser interferometers are connected to the controller 115 and serve to obtain accurate data concerning the position of the wafer stage 131 in the X-direction and Y-direction, respectively. The positional data obtained by the laser interferometer 133 is routed to the controller 115.

To position the wafer stage 131 at a target position, a respective command is transmitted from the controller 115 to the drive interface 134. The drive interface 134, in response to the command, appropriately energizes the driver 132 to move the wafer stage 131 to the corresponding position. The components 131-134 and 115 functioning in this manner achieve accurate, real-time, feedback control of the position of the wafer stage 131.

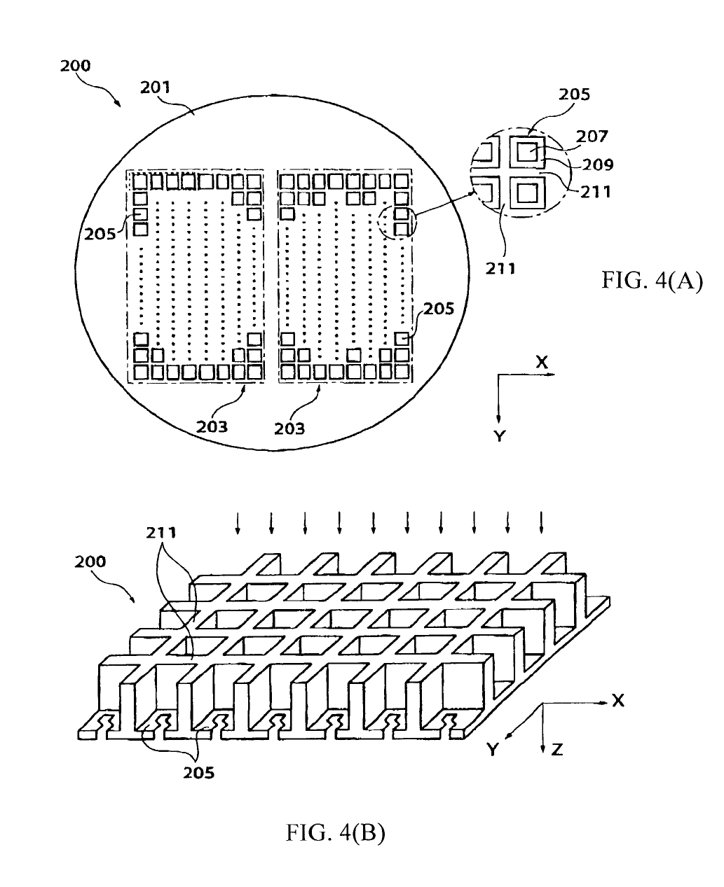

A reticle 200 as used in divided-reticle electron-beam microlithography is shown in FIGS. 4(A)-4(B), wherein FIG. 4(A) is an overall plan view (with partial enlargement), and FIG. 4(B) is an oblique view of a portion of the reticle.

By way of example, the reticle 200 is fabricated from a silicon wafer 201 having a diameter of 200 mm. In the depicted example (FIG. 4(A)), the silicon wafer 201 defines two device-pattern regions 203 each comprising multiple membrane regions 205. The membrane regions 205 are arrayed in a rectilinear manner in the X-direction and Y-direction in the respective device-pattern regions 203.

As shown in detail in the partial enlargement provided in FIG. 3(A), each small membrane region 205 comprises a center portion 207 (the actual respective subfield corresponding to the particular small membrane region 205). The subfield 207 defines the pattern elements in the respective subfield, and is surrounded by a non-patterned “skirt” 209 (skirt). The shape of individual subfields 207 is square, with a linear dimension along each side of 1 mm in this example. The subfields 207 are made by etching the silicon wafer 201, in regions of subfields and associated skirts, to a residual membrane thickness of approximately 2 μm, for example. The respective elements defined in the subfields 207 are formed using a mask-writing technology such as electron-beam writing, followed by etching to remove bulk silicon in the small membrane regions 205.

In each small membrane region 205, the respective skirt 209 is a border zone that is not patterned. During exposure of the respective subfield 207, the edge of the illumination beam falls within the skirt 209. The width of a skirt 209 is approximately 0.065 mm, for example.

Minor struts 211 intersect each other in an X-Y grid manner at the peripheries of the small membrane regions 205. The minor struts 211 function as support members that provide substantial mechanical strength to the reticle 200. The “height” of each minor strut 211 is 725 μm, for example, and the width of each minor strut is approximately 0.3 mm. The respective subfield 207 within each small membrane region 205, surrounded by the respective minor struts 211, constitutes a region that is exposed in a single respective exposure “shot” of the electron-beam microlithography tool.

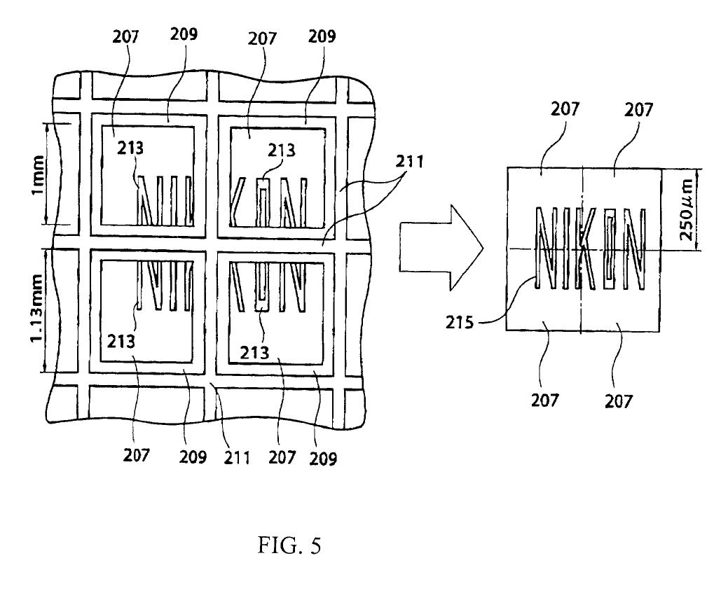

FIG. 5 schematically depicts an exemplary exposure of four subfields from the reticle to a substrate, and shows the manner in which subfield images are stitched together in a contiguous manner on the substrate. As noted, four subfields 207 are shown, each defining respective pattern elements 213. The subfields 207 are arranged two-abreast in both the “vertical” and “horizontal” directions. Respective images of the subfields 207 are individually projected, with demagnification, onto the substrate shown at the right in FIG. 5 to form a single contiguous pattern 215. The demagnification (reduction) ratio is 1/4, for example.

Returning to FIG. 4(A), the portion of the reticle peripheral to the device-pattern regions 203 on the reticle 200 has the same thickness as the struts 211. This peripheral portion of the reticle is the portion that is secured to the reticle chuck 110 on the reticle stage 111 (FIG. 3).

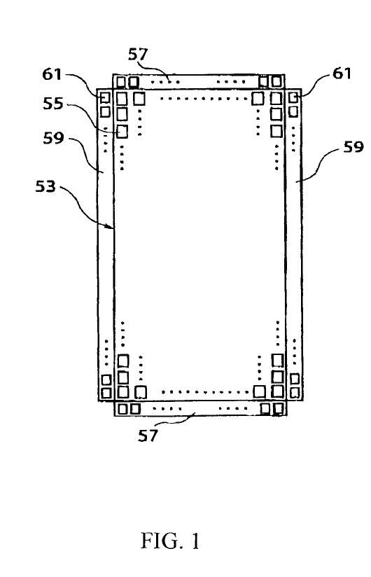

FIG. 1 is a plan view showing certain details of a device-pattern region of a representative embodiment of a reticle. The device-pattern region includes an evaluation-pattern region at the periphery of the device-pattern region.

Specifically, the device-pattern region 53 of this embodiment comprises multiple subfields 55 into which the device pattern is divided as discussed above with reference to FIG. 4. In this embodiment, by way of example, one-hundred rows of subfields 55 (each defining a respective portion of the device pattern) are arranged in the “vertical” direction in the region 53, and forty columns of subfields 55 are arranged in the “horizontal” direction. Exemplary dimensions of the device-pattern region 53 are 132.57 mm “vertical” dimension and 54.43 mm “horizontal” dimension.

The depicted reticle also comprises respective alignment-pattern regions 57 extending along the “upper” and “lower” edge of the device-pattern region 53. Also, respective evaluation-pattern regions 59 extend along the “left” and “right” edges of the device-pattern region 53. In this embodiment each alignment-pattern region 57 comprises forty small membrane regions each comprising a respective subfield that defines an alignment pattern. The alignment patterns are used in a conventional manner during positioning of the substrate and the incident beam and/or during relative positioning of the reticle stage and the substrate stage. Also, in this embodiment, each evaluation-pattern region 59 comprises one-hundred small membrane regions each comprising a respective subfield that defines an evaluation pattern 61.

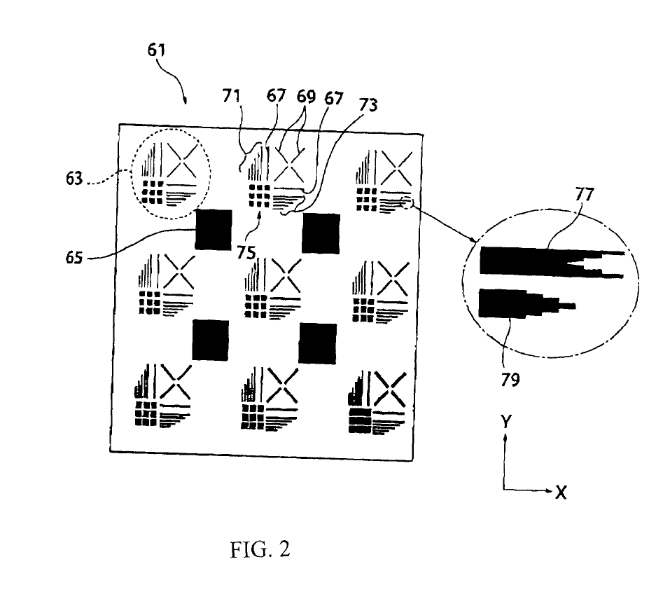

An exemplary evaluation pattern is shown in FIG. 2. The depicted evaluation pattern 61 is defined within each of the subfields of an evaluation-pattern region 59, as discussed above. The evaluation pattern 61 in this example comprises nine mark groups 63 and four apertures 65 arranged as shown. The mark groups 63 are arranged three-by-three in the “vertical” and “horizontal” directions. Each aperture 65 is situated in a respective space flanked by four adjacent mark groups 63. Thus, the apertures 65 are arranged two-by-two in the “vertical” and “horizontal” directions.

Each mark group 63 comprises isolated lines 67, diagonal lines 69, a line group 71 including lines of different length, a line pattern 73 for evaluating fine end-pattern processing, and an array 75 of rectangular apertures. A respective isolated line 67 extends in each of the X-direction and Y-direction. The diagonal lines 69 consist of two colinear lines extending in the +45° direction and two colinear lines extending in the −45° direction. The line group 71 consists of five parallel lines having gradated lengths extending in the Y-direction. As shown in the enlarged portion of the figure, the line pattern 73 for evaluating fine end-pattern processing consists of a line 77 having a stepwise concave terminus and a line 79 having a stepwise convex terminus. The lines 77, 79 are useful for evaluating stitching accuracy between adjacent subfields and between subfields defining complementary pattern portions. Each array 75 of rectangular apertures is arranged in a three-by-three grid.

The widths of the various lines within the mark groups 63 are established so as to provide variation within an approximate range of 200 nm to 1 μm. In the arrays 75 of rectangular apertures, the spacing between individual apertures in each array is progressively narrowed from the upper “left” to the lower “right.”

A reticle as described above is placed in a CPB microlithography system for use in performing transfer of a pattern from the reticle to a sensitive substrate under prescribed conditions. Before commencing transfer of the pattern, the evaluation pattern 61 as transferred to the wafer is evaluated. Evaluating the pattern 61 in this manner includes an evaluation of the influence of proximity effects during reticle writing by evaluating the line widths of the images of the line groups 71. Images of the apertures in the aperture groups 75 reveal differences in the aperture ratios of the respective mark groups 63, allowing the respective influences of the Coulomb effect and the proximity effect to be determined. By measuring the positions of the apertures 65, pattern-position errors resulting from deformation of the reticle membrane in the vicinity of the apertures 65 can be determined.

The evaluation of the evaluation pattern 61 can be performed, for example, by measuring the evaluation pattern using a direct-measurement scanning electron microscope (SEM), an optical microscope, or other charged-particle beam optical system. Alternatively, a patterned beam produced with the evaluation pattern 61 can be measured using, for example, an electron microscope or other optical system. Such evaluation can be conveniently performed based on a projected image formed with the patterned beam, and directly measured with an electron microscope or other charged-particle-beam optical system. Measurement data concerning the evaluation pattern 61 are processed and compared to respective prescribed reference data. If the measured data correspond with the reference data, then the reticle is considered to have passed the evaluation; if not, then the reticle is regarded as having failed the evaluation.

The evaluation pattern 61 can be measured to evaluate the reticle if the same evaluation pattern is provided in advance on the reticle. The evaluation pattern also can be measured between use of different reticles having different device patterns. Hence, evaluation procedures can be standardized, such as performing SEM measurements and processing actual evaluation data. By automating the evaluation protocol, it is possible to perform evaluation operations more efficiently. In any event, the evaluation pattern and method described above allow reticle evaluations to be performed accurately and quickly.

Note that the evaluation pattern 61 also may be used as an alignment pattern.

Whereas the invention has been described in connection with representative embodiments, it will be understood that the invention is not limited to those embodiments. On the contrary, the invention encompasses all modifications, alternatives, and equivalents as may be included within the spirit and scope of the invention, as defined by the appended claims.

What is claimed is:

1. A divided reticle for use in charged-particle-beam (CPB) microlithography, the reticle defining features of a pattern, to be transferred to a substrate, the features of the pattern having differences in at least one transmission characteristic with respect to a reticle membrane, the reticle comprising:
at least one device-pattern region comprising multiple small membrane regions each including a respective subfield defining a respective portion of the pattern to be transferred to the substrate, the small membrane regions being arranged as an array in the device-pattern region; and
at least one evaluation-pattern region, situated outside the device-pattern region on the reticle, including at least one small membrane region defining a respective reticle-evaluation pattern.

2. The reticle of claim 1, wherein the reticle comprises multiple device-pattern regions each including at least one respective evaluation-pattern region.

3. The reticle of claim 1, wherein the evaluation-pattern region flanks an edge of the device-pattern region.

4. The reticle of claim 1, further comprising multiple evaluation-pattern regions flanking respective edges of the device-pattern region.

5. The reticle of claim 1, further comprising at least one alignment-pattern region, situated outside the device-pattern region on the reticle, including at least one small membrane region defining a respective alignment pattern.

6. The reticle of claim 1, wherein the evaluation-pattern region comprises multiple small membrane regions, each defining a respective reticle-evaluation pattern, arranged along an edge of the device-pattern region.

7. The reticle of claim 1, wherein each reticle-evaluation pattern comprises an array of multiple mark groups.

8. The reticle of claim 7, wherein each mark group comprises features selected from the group consisting of isolated lines, diagonal lines, line groups including lines of gradated length, and line patterns for evaluating fine end-pattern processing.

9. The reticle of claim 8, wherein the line pattern for evaluating fine end-pattern processing comprises a first line having a step-wise concave terminus and a second line having a step-wise convex terminus.

10. A method for evaluating a divided reticle for use in performing charged-particle-beam (CPB) microlithography, the reticle defining features of a pattern, to be transferred to a substrate, the features of the pattern having differences in at least one transmission characteristic with respect to a reticle membrane, the method comprising:
configuring the reticle so as to at least one device-pattern region comprising multiple small membrane regions each including a respective subfield defining a respective portion of the pattern to be transferred to the substrate, the small membrane regions being arranged as an array in the device-pattern region, and at least one evaluation-pattern region, situated outside the device-pattern region on the reticle, including at least one small membrane region defining a respective reticle-evaluation pattern;
projecting an image of the reticle-evaluation pattern onto a substrate;
evaluating the projected image by determining one or more of positions, line widths, and shapes of features of the reticle-evaluation pattern as projected onto the substrate, so as to obtain reticle-evaluation data; and
comparing the reticle-evaluation data with predetermined expected data for the reticle.

11. The method of claim 10, further comprising the step of using the reticle for performing CPB microlithography based on results obtained in the comparing step.

12. The method of claim 10, performed before using the reticle for performing CPB microlithography.

13. A method for evaluating a divided reticle for use in performing charged-particle-beam (CPB) microlithography, the reticle defining features of a pattern, to be transferred to a substrate, the features of the pattern having differences in at least one transmission characteristic with respect to a reticle membrane, the method comprising:
configuring the reticle so as to at least one device-pattern region comprising multiple small membrane regions each including a respective subfield defining a respective portion of the pattern to be transferred to the substrate, the small membrane regions being arranged as an array in the device-pattern region, and at least one evaluation-pattern region, situated outside the device-pattern region on the reticle, including at least one small membrane region defining a respective reticle-evaluation pattern;
evaluating one or more of positions, line widths, and shapes of features of the reticle-evaluation pattern using a scanning electron microscope or optical microscope so as to obtain reticle-evaluation data; and
comparing the reticle-evaluation data with predetermined expected data for the reticle.

14. The method of claim 13, further comprising the step of using the reticle for performing CPB microlithography based on results obtained in the comparing step.

15. The method of claim 13, performed before using the reticle for performing CPB microlithography.
